(19) United States
(12) Patent Application Publication
(10) Pub. No.: US 2004/0103274 A1
(43) Pub. Date: May 27, 2004

(54) System and method for transferring user system settings between computer systems and storage medium

(76) Inventors: Kuo Shih-Chieh, Taipei Hsien (TW); O Chih-Ping, Taipei Hsien (TW)

Correspondence Address: TROXELL LAW OFFICE, SUITE 1404, 5205 LEESBURG PIKE, FALLS CHURCH, VA, 22041, US

(21) Appl. No.: 10/667,399

(22) Filed: Sep. 23, 2003

(30) Foreign Application Priority Data
Sep. 23, 2002 (TW) 091121790

(51) Int. Cl. G06F 9/00

(52) U.S. Cl. 713/2

(57) ABSTRACT

The invention provides a method and system for transferring user system settings between a computer system and a storage medium. When transferring the user system settings from the computer system to the storage medium, in response to an user request, scan the computer system to identify the transferable user system settings within the computer system. Retrieve and store the transferable user system settings. Transfer the stored user system settings from the computer system to the storage medium. When transferring the user system settings from the storage medium to the computer system, in response to an user request, scan the computer system to identify the user system settings within the computer system matching the predetermined user system settings stored in the storage medium. Replace the user system settings within the computer system matching the predetermined user system settings by the predetermined user system settings stored in the storage medium.

### FIELD OF THE INVENTION

The present invention relates to a method and system for transferring user system settings between computer systems, and more particularly, to a method and system for transferring, in response to a user request, the user system settings from one computer system to another computer system with a storage medium.

### BACKGROUND OF THE INVENTION

Recently because computers are improved and commonly used, a user may access different computers in different locations, such as working place, recreation areas, and home, etc. Each computer has digital data comprising system settings and data files. However, the system settings and data files of each computer are not exactly the same.

When a user accesses computers in different places, he contacts different system settings and data files, and the different system settings and data files may not be the ones that the user is familiar with. Thus the user needs to reset the system settings and data files according to his needs.

The system settings comprise the system settings subordinate to computer system and the system settings subordinate to users. The system settings subordinate to computer system, such as IP address, DNS server address, gateway/router address, system name, workgroup, and printer permission, do not have to change while used by different users.

However, it is better and convenient for users to use computers with the system settings subordinate to users according to their needs. Therefore, the system settings subordinate to users needs to be changed for different users. The system settings subordinate to users comprise application program interface routines and data files. An example of application program interface routines is external settings of Microsoft windows such as icon font name, font size, window border size, . . . etc. Examples of data files relate to browser settings such as my favorites, or other settings of Microsoft windows office such a address book, mail data record, . . . etc.

The system settings subordinate to users, including application program interface routines and data files, mentioned above are generally known as the user system settings. The system settings and data files that a user is used to use are generally known as the predetermined user system settings. However, it is very complicated and time-consuming to change the user system settings into the predetermined user system settings. Also, some steps may be missed and mistakes may occur. Thus it is necessary to adopt an advanced device and method to effectively retrieve user system settings from one computer system and transfer them to another computer system when needed.

### SUMMARY OF INVENTION

It is therefore a primary objective of the present invention to provide a system and a method for transferring the user system settings between a computer system and a storage medium. The user system settings can be transferred from one computer system to another computer system with the storage medium.

In a preferred embodiment, the present invention provides a method for transferring the user system settings from a computer system to a storage medium. First, scan the computer system to identify the user system settings capable of transferred within the computer system. Next, retrieve and store the user system settings capable of transferred. Next, transfer the stored user system settings from the computer system to the storage medium.

In another preferred embodiment, the present invention provides a method, in response to a first user request, for transferring the predetermined user system settings from a storage medium to a computer system. First, scan the computer system to identify the user system settings within the computer system matching the predetermined user system settings. Next, replace the user system settings within the computer system matching the predetermined user system settings by the predetermined user system settings stored in the storage medium.

It is the advantage of the present invention that the method and the can conveniently and effectively change the system settings and data files from one computer system to another computer system with the storage medium.

The objective of the present invention will undoubtedly become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a block diagram showing a transferring system of transferring the user system settings from a first computer system to a second computer system of the present invention.

FIG. 2 is a block diagram showing two computer systems, and a storage medium in the present invention.

FIG. 3 is a flowchart showing a method of the present invention to transfer the user system settings from the computer system to the storage medium shown in FIG. 2.

FIG. 4 is a flowchart showing a method of the present invention to transfer the user system settings from the storage medium to the computer system shown in FIG. 2.

FIG. 5 is a block diagram showing a computer program product according to another preferred embodiment of the present invention.

### DETAILED DESCRIPTION OF THE INVENTION

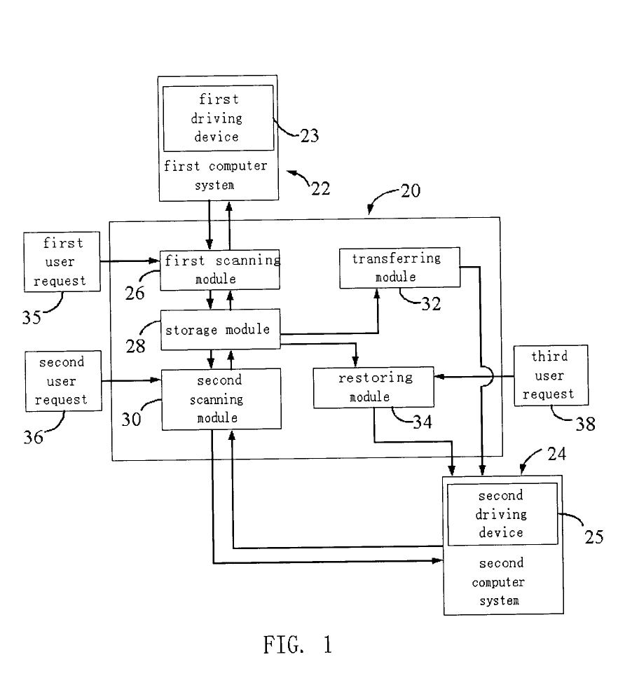

Please refer to FIG. 1. FIG. 1 is a block diagram showing a transferring system 20 for transferring user system settings from a first computer system 22 to a second computer system 24 of the present invention. The present invention is a transferring system 20 for transferring the user system settings from a first computer system 22 to another computer system 22. The transferring system 20 comprises a first scanning module 26, a storage module 28, a second scanning module 30, a transferring module 32, and a restoring module 34.

The first scanning module 26 is, in response to a first user request, for scanning the first computer system 22 to identify the user system settings capable of being transferred within the first computer system 22. The storage module 28 is for retrieving and storing the user system settings, within the first computer system 22, identified by the first scanning module 26. The second scanning module 30 is, in response to a second user request 36, for scanning the second computer system 24 to identify the user system settings matching the user system settings stored in the storage module 28. The transferring module 32 is for replacing the user system stored within the second computer system 24 matching the user system settings stored in the storage module 28 by the user system settings stored in the storage module 28.

The restoring module 34 is for storing the user system settings matching the user system settings stored in the storage module 28 within the second computer system 24. The restoring module 34 is, in response to a third user request 38, also for restoring the replaced user system settings within the second computer system 24 by the original user system settings matching the user system settings stored in the storage module 28. In other words, the restoring module 34 stores the user system settings that is originally stored in the computer system 24 but replaced. When the third user request 38 occurs, the restoring module 34 will restore the original user system settings for the second computer system 24.

Besides, before responding to the third user request, the restoring module 34 can provide a message to ask the third user whether or not to return to the original user system settings of the second computer system 24 before the transferring system 20 leaves the second computer system 24. And the restoring module 34 can further ask the third user whether or not to store the user system settings of the second computer system 24 in the transferring system 20.

The user system settings within the first computer system 22 which can be transferred comprise the transferable data files in the central hierarchical database within the first computer system 22. Besides, the user system settings within the first computer system 22 which can be transferred also comprise the transferable settings regarding a plurality of application program interface routines within the first computer system 22. In other words, the user system settings within the first computer system 22 which can be transferred also comprises the settings matching the predetermined user system settings regarding the plurality of application program interface routines within the first computer system 22.

The first computer system 22 comprises a first driving device 23. The second computer system 24 comprises a second driving device 25. The first driving device 23 and the second driving device 25 both are used for writing/reading the data on the storage module 28. The communication of the driving devices 23 and 25 conform to USB standard or PCMCIA standard.

The storage module 28 is a memory storage device, which can be a soft diskette, an optical disk, a memory stick, or a memory card. Especially, the storage module 28 with flash memory can conform to CompactFlash (CF) standard, MultiMediumCard (MMC) standard, Secure Digital (SD) standard, SmartMedia (SM) standard, Memory Stick (MS) standard, Memory Stick Duo (MSD) standard, or xD-Picture Card (xD-PC) standard.

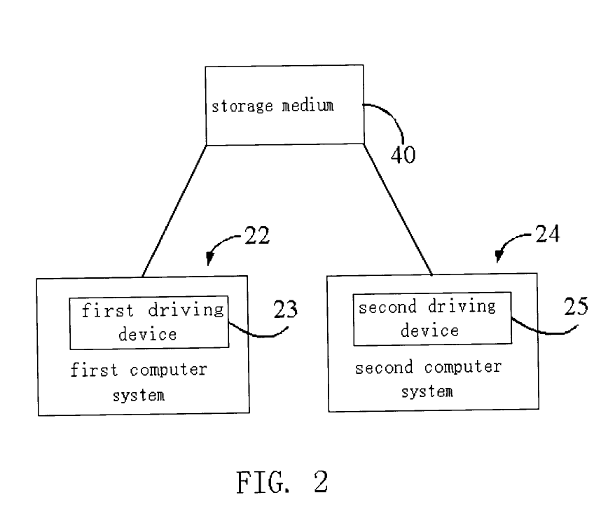

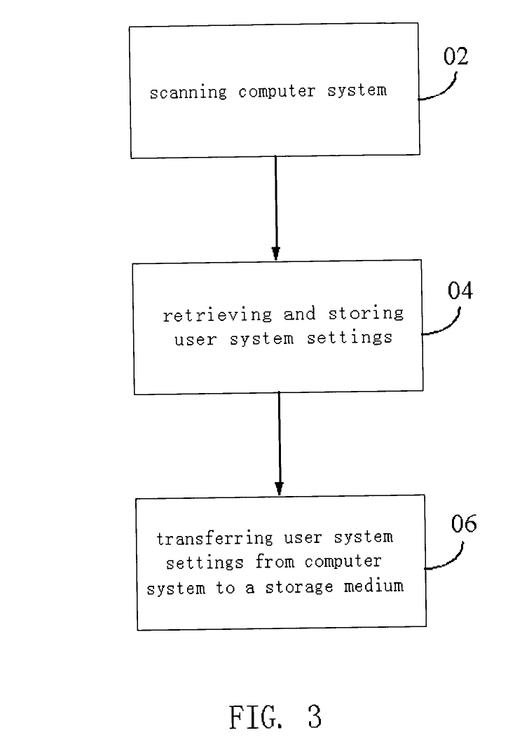

Please refer to FIG. 2 and FIG. 3. FIG. 2 is a block diagram showing two computer systems 22 and 24, and a storage medium 40 in the present invention. FIG. 3 is a flowchart showing a method of the present invention to transfer the user system settings from the computer system 22 to the storage medium 40 shown in FIG. 2. Each of the computer systems 22, 24 respectively comprises a driving device 23, 25 for writing/reading the data on the storage medium 40. And the communication of the driving devices 23 and 25 conform to USB standard or PCMCIA standard. The storage medium 40 can be a soft diskette, an optical disk, a memory stick, or a memory card. Especially, the storage medium 40 with flash memory can conform to CompactFlash (CF) standard, MultiMediumCard (MMC) standard, Secure Digital (SD) standard, SmartMedia (SM) standard, Memory Stick (MS) standard, Memory Stick Duo (MSD) standard, or xD-Picture Card (xD-PC) standard.

The present invention is a method for transferring the user system settings from the computer system 22 to the storage medium 40, which comprises the following steps.

As the step 02 shown in FIG. 3, first, scan the computer system 22 to identify the transferable digital data from all digital data within the computer system 22. Especially, identify the so-called user system settings for those digital data for system setting and data files needed by the user. The step 02 further comprises a step to identify the transferable data files from the data files in the central hierarchical database within the computer system 22. The step 02 also comprises a step to identify the transferable settings from the settings regarding the plurality of application program interface routines within the computer system.

As the step 04 shown in FIG. 3, next, retrieve the user system settings that are needed by the user and transferable, and store these transferable user system settings.

As the step 06 shown in FIG. 3, next, transfer the user system settings retrieved and stored previously from the computer system 22 to the storage medium 40.

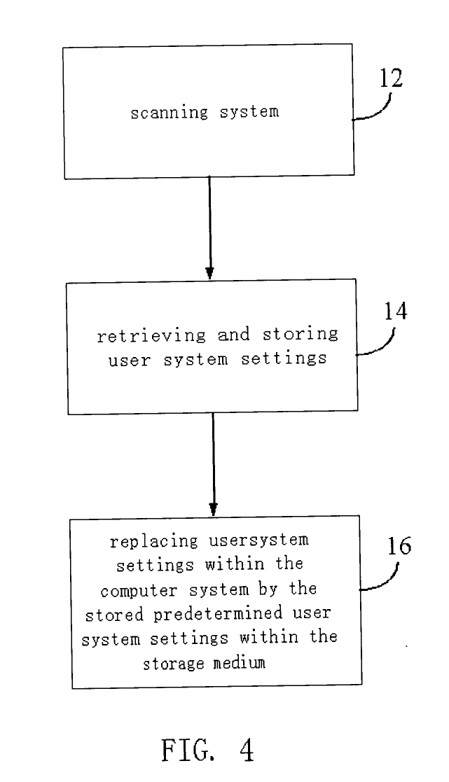

Please refer to FIG. 2 and FIG. 4. FIG. 4 is a flowchart showing a method of the present invention to transfer the user system settings from the storage medium 40 to the computer system 24 shown in FIG. 2. The present invention provides a method, in response to a first user request, for transferring the predetermined user system settings from a storage medium 40 to a computer system 24. The method comprises the following steps.

As the step 12 shown in FIG. 4, first, scan the computer system 24 to identify the user system settings matching the predetermined user system settings within the computer system 24. The transferable digital data with all digital data within the computer system 24, especially the digital data for system settings and data files needed by the user, is called user system settings. The user system settings relating to transferable system settings and data files needed by the user is called the predetermined user system settings. Therefore, the step 12 is to scan the computer 24 to identify the user system settings within the computer system 24 matching the predetermined user system settings within the storage medium 40.

The step 12 comprises a step to identify the transferable data files within data files in a central hierarchical database and within the data files regarding a plurality of application program interface routines within the computer system 24. The step 12 also comprises a step to identify the data files matching the predetermined user system settings from the data files the central hierarchical database and the data files within the settings of the plurality of application program interface routines within the computer system 24.

As the step 14 shown in FIG. 4, next, retrieve the system settings matching the predetermined user system settings within the computer system 24, and store these system settings.

As the step 16 shown in FIG. 4, next, replace the user system settings stored within the computer system 24 matching the predetermined user system settings stored in the storage medium 40 by the predetermined user system settings stored in the storage medium 40.

FIG. 4 and its description relate to the method of the present invention, in response to a first user request, for transferring the stored predetermined user system settings from a storage medium 40 to a computer system 24. Besides, the flow of the method can further extend to, in response to a second user request, restore the original settings within the computer system 24. Followings are the restoring steps. After the step 16 shown in FIG. 4, in response to a second user request, the user system settings that are previously replaced by the predetermined user system settings are restored to the original user system settings matching the predetermined user system settings within the storage medium. In other words, it is to restore the original settings of the computer system.

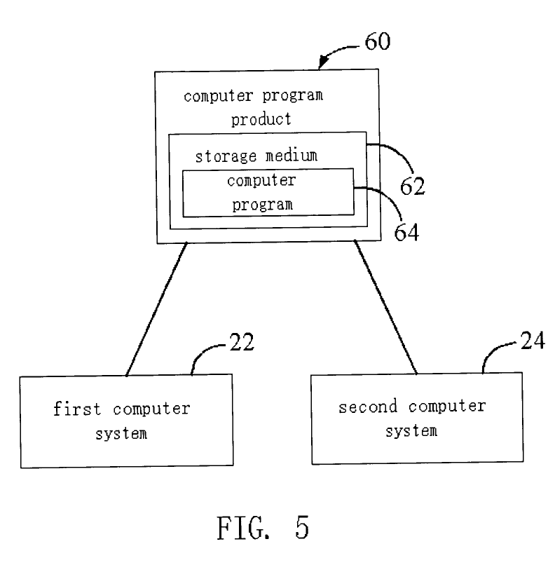

Please refer to FIG. 5. FIG. 5 is a block diagram showing a computer program product 60 according to another preferred embodiment of the present invention. The computer program product 60 of the present invention comprises a storage medium 62. The storage medium 62 has a computer program 64 embedded in the storage medium 62 and stores the predetermined user system settings. The computer program 64 is used for causing a computer system 22 to transfer the user system settings to the storage medium 62, and transferring the stored predetermined user system settings within storage medium 62 to a second computer system 24. As to the related standard of the embodiment of the storage medium 62 is the same as the storage medium 40 shown in FIG. 2.

When a user requests the computer program 64 to transfer the user system settings within the computer system 22 to the storage medium 62, the computer program 64 responds to the user request, scans the computer system 22 to identify the transferable user system settings within the computer system 22, and transfers the stored user system settings to the storage medium 62. As to the details of the computer program 64 executing, these steps are similar to the above description for FIG. 3.

A second user request is for transferring the stored predetermined user system settings within the storage medium 62 to the computer system 24 by using the computer program product 60. The computer program 64 in response to the second user request, processes the steps of scanning the computer system 24 to identify the user system settings within the computer system 24 matched the predetermined user system settings, and replacing the user system settings stored within the computer system 24 matching the predetermined user system settings by the predetermined user system settings stored in the storage medium 62. Besides, when the user requests to restore the original settings of the computer system 24, which is so-call a third user request, the computer program 64 restores the original settings of the computer system 24 in response to the third user request. As to the details of the computer program 64 executing, these steps are similar to the above description for FIG. 4.

Therefore, the present invention provides a method and system by using a storage medium to transfer the user system settings from a computer system 22 to another computer system 24 in response to the user request. The present invention comprises the steps of scanning the computer system 22 to identify the transferable user system settings, and retrieving and storing the transferable user system settings to become the predetermined user system settings within the storage medium. Next, scan the computer system 24, and replace the user system settings stored within the computer system 24 matching the predetermined user system settings by the predetermined user system settings stored in the storage medium. Thereby, the present invention can conveniently and effectively change the system settings and data files within the computer system 24 into the user system settings within the computer system 22.

While the invention has been described in the preferred embodiments, it is understood that the used words are words of description rather than words of limitation and that changes within the purview of the appended claims may be made without departing from the scope and spirit of the invention in its broader aspect.

What is claimed is:

1. A method for transferring, in response to a user request, user system settings from a computer system to a storage medium, the method comprising the steps of:
(a) scanning the computer system to identify the user system settings capable of being transferred within the computer system;
(b) retrieving and storing the user system settings capable of being transferred; and
(c) transferring the stored user system settings from the computer system to the storage medium.

2. The method of claim 1, wherein step (a) further comprises the step of identifying the data files, capable of being transferred, in data files of a central hierarchical database within the computer system.

3. The method of claim 2, wherein step (a) further comprises the step of identifying the settings, capable of being transferred, in settings regarding a plurality of application program interface routines within the computer system.

4. The method of claim 3, wherein the computer system comprises a driving device for recording/reading data from the storage medium, and the communication of the driving device conforms to USB standard or PCMCIA standard.

5. The method of claim 4, wherein the storage medium is one selected from the group consisting of a soft diskette, an optical disk, a memory stick and a memory card.

6. The method of claim 4, the storage medium conforms to one selected from the group consisting of CompactFlash (CF) standard, MultiMediumCard (MMC) standard, Secure Digital (SD) standard, SmartMedia (SM) standard, Memory Stick (MS) standard, Memory Stick Duo (MSD) standard, and xD-Picture Card (xD-PC) standard.

7. A method for transferring, in response to a first user request, predetermined user system settings stored in a storage medium to a computer system, the method comprising the steps of:
(a) scanning the computer system to identify the user system settings within the computer system matching the predetermined user system settings; and
(b) replacing the user system settings within the computer system matching the predetermined user system settings by the predetermined user system settings stored in the storage medium.

8. The method of claim 7, wherein step (a) further comprises the step of identifying the settings in settings regarding a plurality of application program interface routines within the computer system matching the settings of the predetermined user system settings.

9. The method of claim 8, wherein step (a) further comprises the step of identifying the data files in data files of a central hierarchical database within the computer system matching the data files of the predetermined user system settings.

10. The method of claim 9, further comprising the steps of:
before step (b), retrieving and storing the user system settings within the computer system matching the predetermined user system settings; and
after step (b), in response to a second user request, restoring the replaced user system settings by the retrieved and stored user system settings previously within the computer system and matching the predetermined user system settings.

11. The method of claim 10, wherein the computer system comprises a driving device for recording/reading data from the storage medium, and the communication of the driving device conforms to USB standard or PCMCIA standard.

12. The method of claim 11, wherein the storage medium is one selected from the group consisting of a soft diskette, an optical disk, a memory stick and a memory card.

13. The method of claim 11, wherein the storage medium conforms to one selected from the group consisting of CompactFlash (CF) standard, MultiMediumCard (MMC) standard, Secure Digital (SD) standard, SmartMedia (SM) standard, Memory Stick (MS) standard, Memory Stick Duo (MSD) standard, and xD-Picture Card (xD-PC) standard.

14. A system for transferring user system settings from a first computer system to a second computer system, the system comprising:
a first scanning module, in response to a first user request, for scanning the first computer system to identify the user system settings capable of being transferred within the first computer system;
a storage module for retrieving and storing the user system settings, within the first computer system, identified by the first scanning module;
a second scanning module, in response to a second user request, for scanning the second computer system to identify the user system settings matching the user system settings stored in the storage module; and
a transferring module for replacing the user system settings stored within the second computer system matching the user system settings stored in the storage module by the user system settings stored in the storage module.

15. The system of claim 14, wherein the user system settings, capable of being transferred, within the first computer system comprise the data files, capable of being transferred, in data files of a central hierarchical database within the first computer system.

16. The system of claim 15, wherein the user system settings, capable of being transferred, within the first computer system comprise the settings, capable of be transferred, in settings regarding a plurality of application program interface routines within the first computer system.

17. The system of claim 16, further comprising a restoring module for storing the user system settings within the second computer system within the second computer system matching the user system settings stored in the storage module, and restoring the replaced user system settings by the stored matched user system settings in response to a third user request.

18. The system of claim 17, wherein the storage module is one selected from the group consisting of a soft diskette, an optical disk, a memory stick and a memory card.

19. The system of claim 18, wherein the storage module conforms to one selected from the group consisting of CompactFlash (CF) standard, MultiMediumCard (MMC) standard, Secure Digital (SD) standard SmartMedia (SM) standard, Memory Stick (MS) standard, Memory Stick Duo (MSD) standard, and xD-Picture Card (xD-PC) standard.

20. The system of claim 19, wherein the first computer system comprises a first driving device, the second computer system comprises a second driving device, the first driving device and the second driving device are for recording/reading data from the storage module, and communication of the first driving device and communication of the second driving device both conform to USB standard or PCMCIA standard.

21. A computer program product comprising a storage medium having a computer program, embedded in the storage medium, for causing a computer system to transfer user system settings to the storage medium, the computer program performing the steps of:
(a) in response to a user request, scanning the computer system to identify the user system settings capable of being transferred within the computer system;
(b) retrieving and storing the user system settings capable of being transferred; and
(c) transferring the stored selected user system settings from the computer system to the storage medium.

22. The computer program product of claim 21, wherein step (a) further comprises the step of identifying data files, capable of being transferred, in data files of a central hierarchical database within the computer system.

23. The computer program product of claim 22, wherein step (a) further comprises the step of identifying the settings, capable of being transferred, in settings regarding a plurality of application program interface routines within the computer system.

24. The computer program product of claim 23, wherein the computer system comprises a driving device for recording/reading data from the storage medium, and communication of the driving device conforms to USB standard or PCMCIA standard.

25. The computer program product of claim 24, wherein the storage medium is one selected from the group consisting of a soft diskette, an optical disk, a memory stick and a memory card.

26. The computer program product of claim 24, the storage medium conforms to one selected from the group consisting of CompactFlash (CF) standard, MultiMediumCard (MMC) standard and Secure Digital (SD) standard SmartMedia (SM) standard, Memory Stick (MS) standard, Memory Stick Duo (MSD) standard, and xD-Picture Card (xD-PC) standard.

27. A computer program product comprising a storage medium having a computer program embedded in the storage medium, and stored predetermined user system settings within the storage medium, for causing the storage medium system to transfer the stored predetermined user system settings to a computer system, the computer program performing the steps of:
(a) in response to a first user request, scanning the computer system to identify user system settings within the computer system matching the predetermined user system settings; and
(b) replacing the user system settings within the computer system matching the predetermined user system settings by the predetermined user system settings stored in the storage medium.

28. The computer program product of claim 27, wherein step (a) further comprises the step of identifying the settings in settings regarding a plurality of application program interface routines within the computer system matching the settings of the predetermined user system settings.

29. The computer program product of claim 28, wherein step (a) further comprises the step of identifying the data files in data files of a central hierarchical database within the computer system matching the data files of the predetermined user system settings.

30. The computer program product of claim 29, further comprising the steps of:
before step (b), retrieving and storing the user system settings within the computer system matching the predetermined user system settings; and
after step (b), in response a second user request, restoring the replaced user system settings by the retrieved and stored user system settings previously within the computer system and matching the predetermined user system settings.

31. The computer program product of claim 30, wherein the computer system comprises a driving device for recording/reading data from the storage medium, and the communication of the driving device conforms to USB standard or PCMCIA standard.

32. The computer program product of claim 31, wherein the storage medium is one selected from the group consisting of a soft diskette, an optical disk, a memory stick, and a memory card.

33. The computer program product of claim 31, the storage medium conforms to one selected from the group consisting of CompactFlash (CF) standard, MultiMediumCard (MMC) standard, Secure Digital (SD) standard SmartMedia (SM) standard, Memory Stick (MS) standard, Memory Stick Duo (MSD) standard, and xD-Picture Card (xD-PC) standard.
